(19) United States
(12) Patent Application Publication
(10) Pub. No.: US 2023/0058228 A1
(43) Pub. Date: Feb. 23, 2023

(54) IMAGE PROCESSING APPARATUS, IMAGE PROCESSING METHOD, AND STORAGE MEDIUM FOR GENERATING IMAGE OF MIXED WORLD

(71) Applicant: CANON KABUSHIKI KAISHA, Tokyo (JP)

(72) Inventor: Takateru Kyogoku, Tochigi (JP)

(21) Appl. No.: 17/820,129

(22) Filed: Aug. 16, 2022

(30) Foreign Application Priority Data
Aug. 19, 2021 (JP) 2021-133923

(51) Int. Cl. G06T 19/20; G06T 19/00; G06T 7/20; G06T 7/70; G06T 7/507

(52) U.S. Cl. CPC G06T 19/20; G06T 19/006; G06T 7/20; G06T 7/70; G06T 7/507; G06T 2207/10016; G06T 2207/10028

(57) ABSTRACT

An image processing apparatus that generates an image of a mixed world by superimposing at least one virtual object on an image of a real world includes an acquisition unit configured to acquire information related to a motion status of a user of the image processing apparatus, a determination unit configured to determine a position for placing the at least one virtual object in the image of the real world, based on the motion status acquired by the acquisition unit, and an image processing unit configured to generate an image in which the at least one virtual object is placed at the position determined by the determination unit. The determination unit determines a position corresponding to a direction in which the user moves as the position for placing the at least one virtual object.

### BACKGROUND

### Field

The present disclosure relates to image processing apparatus, image processing methods, and storage media.

### Description of the Related Art

Recently, techniques have been developed for providing a mixed world in an environment having both a real world and a virtual object, as represented by augmented reality (AR) and mixed reality (MR). For example, such a technique provides a user with a mixed world where a virtual object is superimposed on a video image of the real world in front of an eye or eyes of the user with a head mount display (HMD) worn on the head. It also includes various types of sensors that detect the motion of the user to allow the motion of the user to synchronize the motion in a mixed world, which provides the user with an experience that the user have never had.

That allows the user to freely move around in the mixed world as if the user were in the real world, which improves a sense of immersion, but may cause the use to pay less attention to the real world. Thus it is important to reduce the level of attention to the virtual object in a dangerous situation. As a technique for reducing the level of attention to a virtual object depending on a situation, Japanese Patent Application Laid-Open No. 2015-228095 discusses a technique of estimating a stoppage and a movement of a user and changing the transparency of a superimposed image during the movement.

When a user is absorbed in a virtual object as described above, the user can have an accident by failing to sense the danger in the real world. For example, a user can fail to notice a car coming from ahead while looking at a virtual object displayed on a screen with the head down. In the technique discussed in Japanese Patent Application Laid-Open No. 2015-228095, even if the transparency of a virtual object is increased, the user may keep looking at the virtual object, and thus miss the opportunity to sense the danger.

### SUMMARY

The present disclosure is directed to preventing a visual effect in a mixed world from being impaired, while preventing the loss of the opportunity to sense the danger in the real world in experience in the mixed world where a virtual object is superimposed on the real world.

According to an aspect of the present disclosure, an image processing apparatus that generates an image of a mixed world by superimposing at least one virtual object on an image of a real world includes an acquisition unit configured to acquire information related to a motion status of a user of the image processing apparatus, a determination unit configured to determine a position for placing the at least one virtual object in the image of the real world, based on the motion status acquired by the acquisition unit, and an image processing unit configured to generate an image in which the at least one virtual object is placed at the position determined by the determination unit. The determination unit determines a position corresponding to a direction in which the user moves as the position for placing the at least one virtual object. The acquisition unit, the determination unit, and the image processing unit are implemented via at least one processor and/or at least one circuit.

Further features of the present disclosure will become apparent from the following description of exemplary embodiments with reference to the attached drawings.

### BRIEF DESCRIPTION OF THE DRAWINGS

FIG. 1 illustrates examples of an image on which a virtual object is superimposed according to a first exemplary embodiment.

FIG. 2 is a block diagram illustrating an example of the hardware configuration of an image processing apparatus.

FIG. 3 is a block diagram illustrating an example of the functional configuration of the image processing apparatus.

FIG. 4 is a diagram illustrating an example of motion status data.

FIG. 5 is a diagram illustrating an example of relocation data according to the first exemplary embodiment.

FIG. 6 is a flowchart illustrating an example of a processing procedure to be performed by an information input unit.

FIG. 7 is a flowchart illustrating an example of a processing procedure for updating relocation data.

FIG. 8 is a flowchart illustrating an example of a detailed processing procedure for updating relocation coordinates.

FIG. 9 is a flowchart illustrating an example of a processing procedure performed by an image processing unit.

FIG. 10 is a diagram illustrating examples of an image on which a virtual object is superimposed according to a second exemplary embodiment.

FIG. 11 is a diagram illustrating an example of relocation data according to the second exemplary embodiment.

FIG. 12 is a flowchart illustrating an example of a processing procedure for calculating relocation coordinates of a virtual object according to the second exemplary embodiment.

### DESCRIPTION OF THE EMBODIMENTS

A first exemplary embodiment of the present disclosure will be described with reference to some drawings.

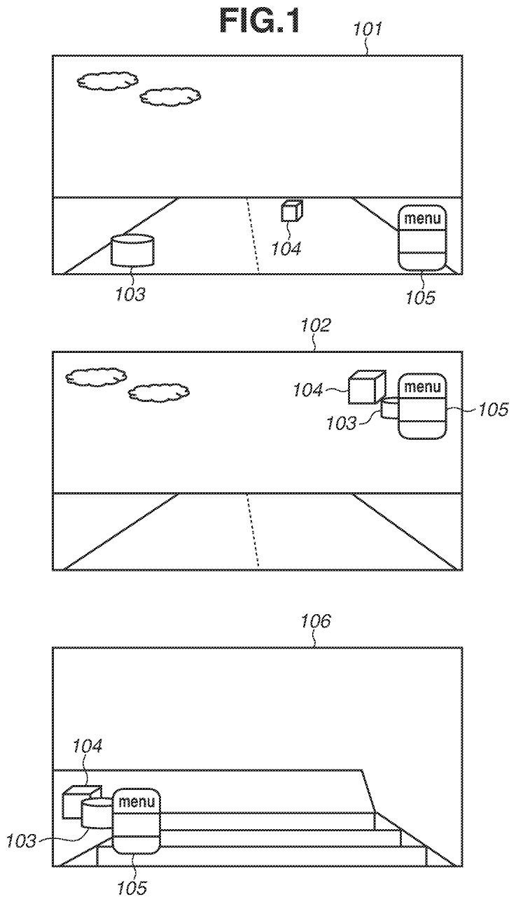

FIG. 1 illustrates examples of an image displayed by an image processing apparatus in the present exemplary embodiment. In FIG. 1, an image 101 is an image example when a user is at a stop. In the image 101, a virtual object 103, a virtual object 104, and a virtual object 105 are each superimposed on coordinates requested by an application in order to provide a mixed world. Meanwhile, an image 102 is an image example when a person (a user) wearing a head mount display (HMD) is walking forward. When the user starts walking, the virtual object 103, the virtual object 104, and the virtual object 105 are each relocated to predetermined coordinates.

In this process, the relocation is performed over a plurality of rendering frames, and the virtual objects are displayed with a visual effect for making the virtual objects each gradually move from the coordinates indicated in the image 101 to the coordinates indicated in the image 102 when the user is walking forward. In the present exemplary embodiment, the virtual objects are relocated above the center of the screen for the purpose of raising the line of sight of the user in order to avoid risk, when the user is walking forward.

In the present exemplary embodiment, along with the start of the movement of the virtual objects for the relocation, the sizes of the virtual objects, a method of displaying the condition of overlap between the virtual objects, a polygon model, and a method of rendering shadow and lighting of texture are changed. In the description of the present exemplary embodiment, the way of rendering each of the virtual objects is changed as follows, in the figures including FIG. 1. As for the size of the virtual object, an example is given in which the virtual object 103 is changed to half the size when being displayed and the virtual object 104 is changed to twice (double) the original size of the virtual object 104. As for a method of displaying the condition of overlap between the virtual objects, an example is given in which the virtual object 105, the virtual object 104, and the virtual object 103 are arranged in this order from front to back. As for the polygon model, an example is given in which the quality of the virtual object 103 is changed to low quality, the quality of the virtual object 104 is changed to high quality, and the quality of the virtual object 105 remains unchanged. As for a method of rendering shadow and lighting of texture, an example is given in which the rendering for the virtual object 103 and the virtual object 104 is omitted but is applied to the virtual object 105.

An image 106 is an image example when the user is descending stairs. In the present exemplary embodiment, the virtual objects are relocated below the center of the screen for the purpose of lowering the line of sight of the user in order to avoid risk, when the user is moving forward and downward such as when the user is descending stairs. The change of the size of the virtual object and the method of displaying the overlap condition are similar to those in the image 102 when the user is walking forward.

In the present exemplary embodiment, the frame rate for displaying the image is changed depending on the status of the user's being at a stop, walking forward, and descending stairs. High quality is set for the user's being at a stop, and low quality is set for the other motion statuses. For example, the frame rate is 120 fps (frame per second) for the user's being at a stop, and 30 fps for the other motion statuses.

The above-described setting is an example in the present exemplary embodiment, and setting/initial setting values different form this setting may be provided. The coordinates for relocating virtual objects as represented by the example illustrated in FIG. 1 is not limited thereto and may be different from those in FIG. 1. Further, although the image 102 when the user is walking forward is illustrated, the action of a user when a relocation of virtual objects is made may be triggered by other actions. For example, the coordinates for relocation can be changed depending on the type of movement in the direction such as frontward, backward, leftward, rightward, upward, or downward direction in the screen.

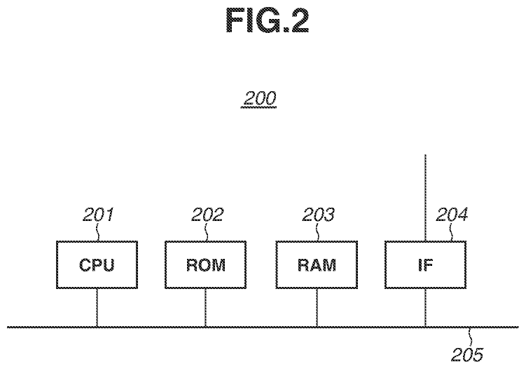

FIG. 2 is a block diagram illustrating an example of the hardware configuration of an image processing apparatus 200 that outputs the images in FIG. 1. FIG. 2 illustrates a central processing unit (CPU) 201 as a processor, a read only memory (ROM) 202, a random access memory (RAM) 203, and an interface (I/F) 204 as an external interface.

The image processing apparatus 200 in the present exemplary embodiment includes the CPU 201, the ROM 202, the RAM 203, and the I/F 204, all of which are connected to one another by a bus 205. The CPU 201 controls the operation of the image processing apparatus 200, and a program loaded into the ROM 202 or the RAM 203 carries out processing in flowcharts described below. Further, the RAM 203 is also used as a work memory that stores temporary data for the processing performed in the CPU 201, and also functions as an image buffer that temporarily holds image data to be displayed. The I/F 204 is an interface for communicating with the outside, and image data about a real world and data for determining the status of a user are input to and image data to be displayed is output from the I/F 204.

Although one CPU is illustrated in FIG. 2, the image processing apparatus may be performed by a plurality of processors. In addition, a supplementary component such as a graphics processing unit (GPU) may be included. Further, although the RAM 203 is illustrated as a component for providing a temporary work memory, second and third storage areas may be provided using the same or different media. As other media, a hard disk drive (HDD), a solid state drive (SSD), and other types of medium are conceivable. The configuration of the bus 205 is not limited to this example, and components may be connected in multiple stages. To implement the present exemplary embodiment, the configuration in FIG. 2 is included in the HMD. However, the present exemplary embodiment is not limited thereto, and some or all of the components in FIG. 2 may be connected to a device by wire or wirelessly, separately from the HMD.

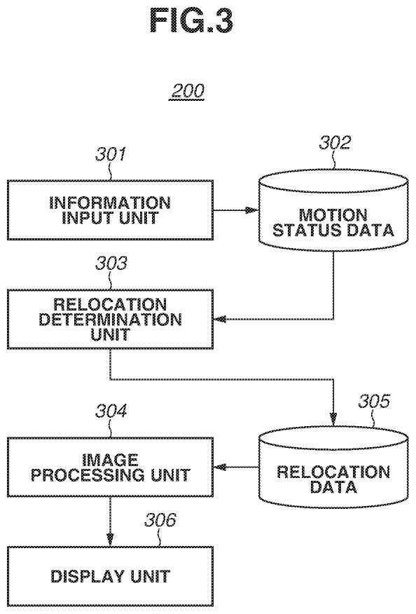

FIG. 3 is a block diagram illustrating an example of the functional configuration of the image processing apparatus 200.

In FIG. 3, an information input unit 301 receives status data for determining the motion status of a user input from the I/F 204, and updates motion status data 302 based on the received status data. Here, the status data is data obtained from various sensors arranged in the HMD, and includes information such as the current position, moving speed, and orientation of the user. A relocation determination unit 303 determines whether to relocate a virtual object using the motion status data 302. Further, if the relocation determination unit 303 determines to relocate the virtual object, the relocation determination unit 303 holds information for relocation as relocation data 305. An image processing unit 304 creates an image of each frame using the relocation data 305, and outputs the created image to a display unit 306. In generating the image of each frame, the image processing unit 304 acquires data about an image of the real world from a camera attached to the HMD via the I/F 204, and superimposes the virtual object on the image of the real world, based on the relocation data 305. That allows the user to visually recognize the image examples illustrated in FIG. 1.

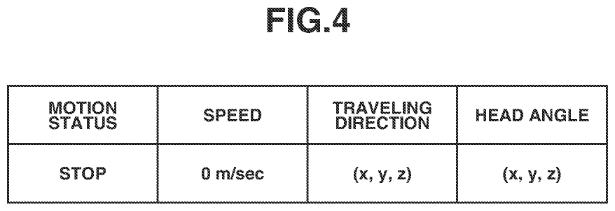

FIG. 4 illustrates an example of the motion status data 302. In the present exemplary embodiment, as described above, the information input unit 301 receives the status data about the user via the I/F 204, updates the motion status data 302 based on the received status data, and holds the result. As illustrated in FIG. 4, the motion status data 302 includes information about the motion status, speed, traveling direction, and head angle of the user.

An item “motion status” refers to information about stop, walking, or descending. Part or all of information such as frontward, backward, leftward, rightward, upward, and downward directions in the screen may be used. Alternatively, as for descending, information may be obtained from “traveling direction” to be described below, and no information may be held as the motion status. An item “speed” refers to the moving speed of the user. An item “traveling direction” refers to the vector of the traveling direction of the user. An item “head angle” refers to the vector of the orientation of the head of the user. Further, in the example illustrated in FIG. 4, the information about “speed” is held as the motion status data 302, but information in a different form may be held. For example, “acceleration” may be held as an item. Alternatively, the concept of a length may be added to the vector of the traveling direction, and information such as the amount of movement in units of time may be held.

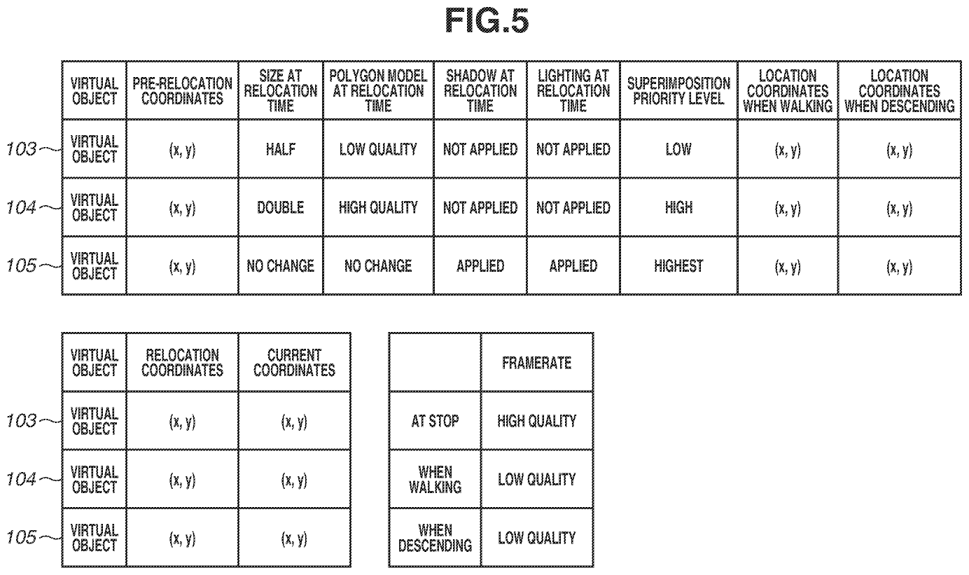

FIG. 5 illustrates an example of the relocation data 305. The relocation determination unit 303 holds the relocation data 305 about the virtual object 103, the virtual object 104, and the virtual object 105.

In FIG. 5, an item “pre-relocation coordinates” refers to coordinates requested by the application to be output for a mixed world. For example, this item indicates the coordinates of the virtual object 103, the virtual object 104, and the virtual object 105 in the image 101 when the user is at a stop in FIG. 1.

An item “size at relocation time” refers to the size of the virtual object at the time of relocation. For example, the item for the virtual object 103 in FIG. 1 is predefined as “half”. A length-to-width ratio may be predefined to vary as the size is changed. An item “polygon model at relocation time” refers to information about the polygon model of the virtual object to be rendered at the time of relocation. In the present exemplary embodiment, two types of low quality and high quality are prepared beforehand for each of the virtual objects, and whether to change the pre-relocation polygon model and which one of these types is to be displayed when the polygon model is changed are defined. A polygon model may be added to this column and the information may be defined to include the value of the added polygon model.

An item “shadow at relocation time” refers to shadow information to be applied to the texture of the virtual object to be rendered at the time of relocation. In the present exemplary embodiment, whether to render the texture using the shadow information is defined by being expressed as applied/not applied. An item “lighting at relocation time” refers to lighting information to be applied to the texture of the virtual object to be rendered at the time of relocation. In the present exemplary embodiment, whether to render the texture using the lighting information is defined by being expressed as applied/not applied.

For the shadow and the lighting at relocation time, an image processing technique to be applied to the texture may be defined.

An item “superimposition priority level” refers to information about the method for displaying the overlap condition between the virtual objects after the relocation. In the present exemplary embodiment, this is expressed in three grades as highest, high, and low, and as the priority level is higher, the virtual object is displayed further frontward. An integer may be used as the superimposition priority level, or the priority level may be changed. An item “location coordinates when walking” refers to relocation coordinates when the user is walking forward, and this is defined using, for example, the coordinates indicated in the image 102 when the user is walking forward in FIG. 1. An item “location coordinates when descending” refers to relocation coordinates when the user is descending stairs, and this is defined using, for example, the coordinates indicated in the image 106 when the user is descending stairs in FIG. 1.

An item “relocation coordinates” refers to relocation coordinates depending on the motion status of the current user. The item holds the pre-relocation coordinates, the location coordinates when walking, or the location coordinates when descending. An item “current coordinates” refers to display coordinates in the corresponding frame during relocation. An item “frame rate” refers to the quality of the frame rate for each motion status, and this is defined as high quality or low quality. The frame rate may be defined using a specific value (fps) for each motion status.

The types of values indicated as the size at relocation time, the polygon model at relocation time, the shadow at relocation time, the lighting at relocation time, the superimposition priority level, and the frame rate described in the present exemplary embodiment are not limited to the example described above. One or more pieces of coordinate information may be held based on a threshold of a speed at the time of walking, as the location coordinates when walking described in the present exemplary embodiment. For example, the information may be in a form divided into walking and running. Alternatively, a relocation to different coordinates every 2 m/s may be performed.

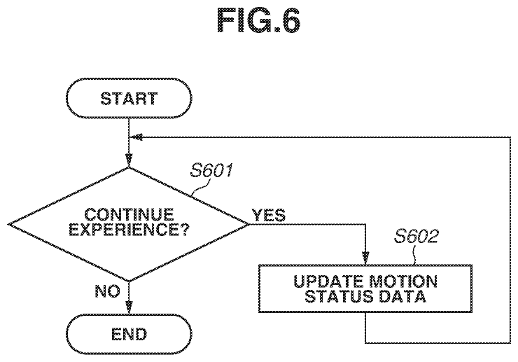

FIG. 6 is a flowchart illustrating an example of a processing procedure performed by the information input unit 301. The processing in FIG. 6 starts when the user starts experiencing a mixed world with the HMD on the user, but the processing in FIG. 6 may start on the start of the screen display on the HMD.

In step S601, the information input unit 301 determines whether to continue the experience of the mixed world. As a result of this determination, if the experience of the mixed world is to be continued (YES in step S601), the processing proceeds to step S602. Otherwise (NO in step S601), the processing ends.

In step S602, the information input unit 301 interprets the status data about the user obtained via the I/F 204, and updates the data about the motion status, the speed, the traveling direction, and the head angle in the motion status data 302 based on the interpreted status data.

In the present exemplary embodiment, the method has been described of constantly acquiring the status data about the user and updating the motion status data 302, but the timing of the update is not particularly limited. For example, the update may be performed every frame, or may be performed in response to a change in the status data about the user obtained via the I/F 204.

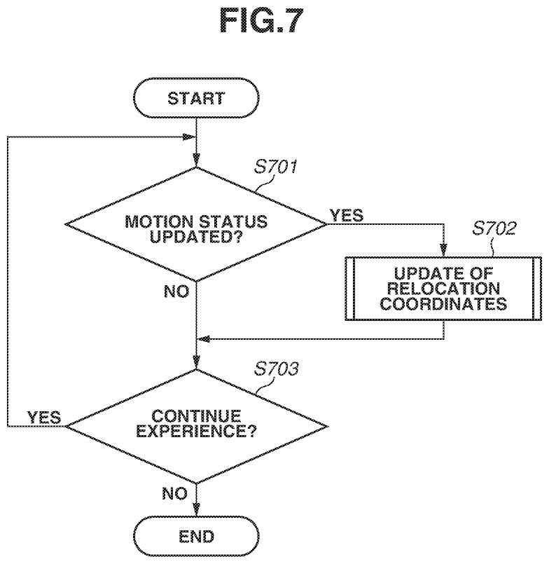

FIG. 7 is a flowchart illustrating an example of a processing procedure for updating the relocation data 305 by the relocation determination unit 303. This processing starts when the user starts experiencing the mixed world with the HMD on the user, or at the timing of the start of screen display on the HMD. The processing may be started for each frame output so that this processing can be utilized in image processing on the frame.

In step S701, the relocation determination unit 303 determines whether the information about the motion status data 302 is updated. As a result of this determination, if the information is updated (YES in step S701), the processing proceeds to step S702. Otherwise (NO in step S701), the processing proceeds to step S703.

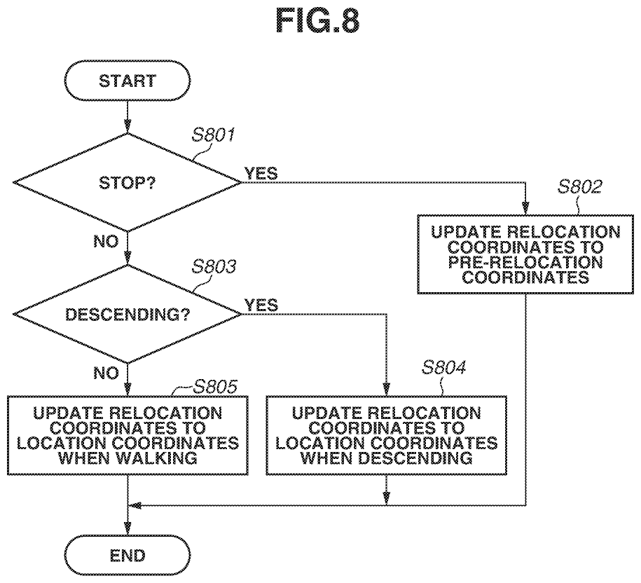

In step S702, the relocation determination unit 303 updates the relocation coordinates of each of the virtual objects of the relocation data 305 based on the updated information about the motion status data 302. The processing will be specifically described below with reference to FIG. 8.

In step S703, the relocation determination unit 303 determines whether to continue the experience of the mixed world. As a result of this determination, if the experience of the mixed world is to be continued (YES in step S703), the processing returns to step S701. Otherwise (No in step S703), the processing ends.

FIG. 8 is a flowchart illustrating an example of the detailed processing procedure for updating the relocation coordinates by the relocation determination unit 303 in step S702. This flowchart illustrates the processing performed in step S702 in FIG. 7.

In step S801, the relocation determination unit 303 determines whether the current motion status in the motion status data 302 indicates stop. As a result of this determination, if the motion status indicates stop (YES in step S801), the processing proceeds to step S802. Otherwise (NO in step S801) the processing proceeds to step S803.

In step S802, the relocation determination unit 303 updates the relocation coordinates of the relocation data 305 with the pre-relocation coordinates, and the processing ends.

In step S803, the relocation determination unit 303 determines whether the motion status of the motion status data 302 indicates descending. As a result of this determination, if the motion status indicates descending (YES in step S803), the processing proceeds to step S804. Otherwise (NO in step S803) the processing proceeds to step S805.

In step S804, the relocation determination unit 303 updates the relocation coordinates of the relocation data 305 with the location coordinates when descending, and the processing ends.

In step S805, because the motion status of the motion status data 302 indicates walking, the relocation determination unit 303 updates the relocation coordinates of the relocation data 305 with the location coordinates when walking, and the processing ends. The processing order depending on the type of the motion status described in the present exemplary embodiment is not limited to this example, and the processing order may be changed. Alternatively, the processing may be further changed depending on the speed, by referring to the speed of the motion status data 302 during walking.

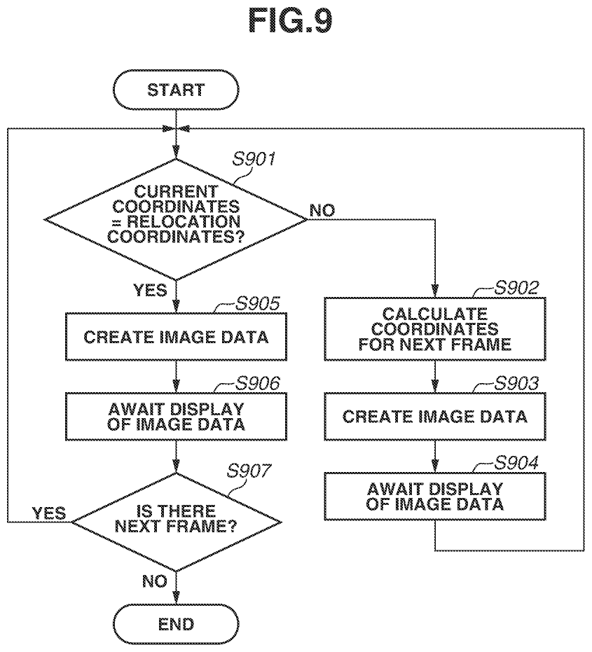

FIG. 9 is a flowchart illustrating an example of a processing procedure performed by the image processing unit 304. This processing is started in response to an input of the image of the real world.

In step S901, the image processing unit 304 determines whether “current coordinates” of the relocation data 305 are identical to the relocation coordinates. As a result of this determination, if the current coordinates are identical to the relocation coordinates (YES in step S901), the processing proceeds to step S905. Otherwise (NO in step S901) the processing proceeds to step S902.

In step S902, the image processing unit 304 calculates the coordinates of each of the virtual objects to be displayed in the next frame, and updates the current coordinates of the relocation data 305 with the calculated coordinates. The new current coordinates can be calculated, on the assumption that the user is moving from the current coordinates before update, to the relocation coordinates as target coordinates, at a constant speed.

In step S903, the image processing unit 304 creates image data to be displayed on the display unit 306 by superimposing the virtual object on the image of the real world based on the information about the relocation data 305, and stores the created image data into the image buffer. Here, the image processing unit 304 refers to the information about the polygon model at relocation time, the shadow at relocation time, and the lighting at relocation time of the relocation data 305, as image processing information. Further, if a value other than “no change” is predefined as the size at relocation time in the relocation data 305, the image processing unit 304 calculates a magnification, on the assumption that the user is moving from the current coordinates before update, to the relocation coordinates as the target coordinates, at a constant speed, and performs enlargement or reduction on the virtual object based on the calculated magnification for adjustment.

In step S904, the image processing unit 304 awaits display on the display unit 306 of the image data stored into the image buffer in step S903, and the processing returns to step S901.

On the other hand, in step S905, the image processing unit 304 creates image data to be displayed on the display unit 306 by superimposing the virtual object on the image of the real world based on the information about the relocation data 305, and stores the created image data into the image buffer. In this case, the virtual object is displayed at the relocation coordinates, and its image data is generated based on the size, the polygon model, and other data predefined in the relocation data 305.

In step S906, the image processing unit 304 awaits display on the display unit 306 of the image data stored into the image buffer in step S905.

In step S907, the image processing unit 304 determines whether there is a frame to be displayed next. As a result of this determination, if there is a frame to be displayed next (YES in step S907), the processing returns to step S901. Otherwise (NO in step S907) the processing ends.

The described above technique according to the present exemplary embodiment provides the relocation of a virtual object while maintaining a visual effect to prevent an experience of a user from being impaired, while preventing loss of an opportunity to sense the danger in the real world.

A second exemplary embodiment will be described. In the present exemplary embodiment, an example will be described of holding information about the image area for relocating each virtual object to, instead of holding coordinate information about each virtual object in relocating virtual objects. The internal configurations of an image processing apparatus according to the present exemplary embodiment are similar to those in FIGS. 2 and 3, and thus the description thereof will be omitted. The difference from the first exemplary embodiment will be described.

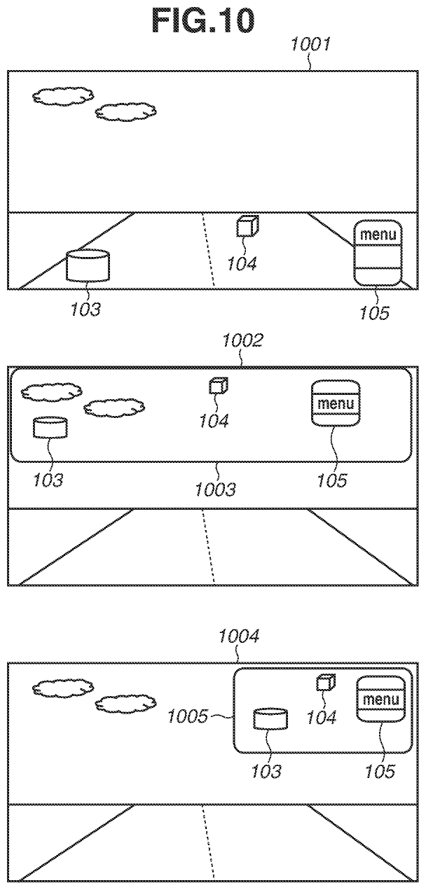

FIG. 10 illustrates examples of an image to be displayed in the present exemplary embodiment. An image 1001 is an image example when a user is at a stop. An image 1002 is an image example when the user is walking forward. As with the first exemplary embodiment, when the user starts walking, a virtual object 103, a virtual object 104, and a virtual object 105 each are relocated to the illustrated coordinates. In the present exemplary embodiment, each of the virtual objects is mapped to an area 1003 in an upper part, the area of which is one-third of the screen, at the time the user starts walking. An image 1004 is an image example when the user is running forward. In the present exemplary embodiment, when the user starts running, each of the virtual objects is mapped to an area 1005 in an upper right part, which occupies the area composed of vertically one-third and horizontally one-third of the screen.

Further, likewise, an image area to which the virtual objects are relocated varies between when walking and when running, when the user descends while moving forward such as when descending stairs, although not illustrated in FIG. 10. Specifically, each of the virtual objects is mapped to an area in a lower part, which is one-third of the screen, at the time when the user starts descending at a walking speed, and each of the virtual objects is mapped to an area in a lower right part, which is vertically one-third and horizontally one-third of the screen, at the time when the user starts descending at a run.

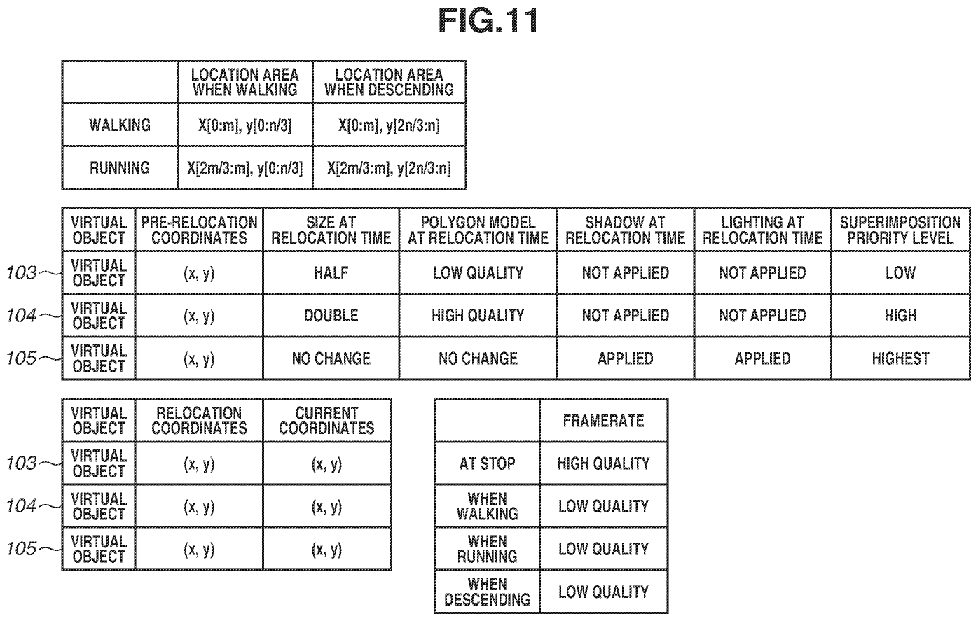

FIG. 11 illustrates an example of relocation data 305 in the present exemplary embodiment. In the present exemplary embodiment, as compared with the example in FIG. 5, the location areas at times of walking and running are added, while the location coordinates when walking and the location coordinates when descending are deleted. An item “location area when walking” and an item “location area when descending” hold information about a mapping area for calculating relocation coordinates of a virtual object when walking and that when running, respectively, where “m” represents a coordinate size in width from the coordinate of the left end that is 0, and “n” represents a coordinate size in length from the coordinate of the upper end that is 0. Further, an item “relocation coordinates” holds mapping coordinates calculated in processing to be described below by a relocation determination unit 303.

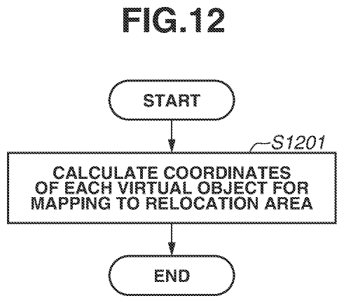

FIG. 12 is a flowchart illustrating an example of a processing procedure for calculating the relocation coordinates of a virtual object in the present exemplary embodiment. The processing illustrated in FIG. 12 is performed in place of the processing of step S804 and step S805 in FIG. 8.

In step S1201, the relocation determination unit 303 determines the image area of the mapping destination based on the speed in motion status data 302, and further acquires information about the location area when walking and the location area when descending. First, the relocation determination unit 303 determines whether the user is walking or running based on “speed” in the motion status data 302, and determines that the user is running if the speed is more than or equal to a threshold in this processing. Subsequently, the relocation determination unit 303 acquires the information about “location area when walking” or “location area when descending” in walking or running. The relocation determination unit 303 then calculates relocation coordinates for mapping in the corresponding location area. Which position in the location area when walking or the location area when descending to be determined to be the relocation coordinates is not limited, and any relocation coordinates may be determined if the relocation coordinates are within the corresponding location area.

The described above technique according to the present exemplary embodiment allows holding image area information related to a range for relocating each virtual object to without holding coordinate information about each virtual object beforehand, in relocating virtual objects.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2021-133923, filed Aug. 19, 2021, which is hereby incorporated by reference herein in its entirety.

What is claimed is:

1. An image processing apparatus that generates an image of a mixed world by superimposing at least one virtual object on an image of a real world, the image processing apparatus comprising:
at least one memory storing instructions; and
at least one processor that, upon execution of the instructions, is configured to operate as:
an acquisition unit configured to acquire information related to a motion status of a user of the image processing apparatus;
a determination unit configured to determine, based on the acquired motion status information, a position for placing the at least one virtual object in the image of the real world; and
an image processing unit configured to generate an image in which the at least one virtual object is placed at the determined position,
wherein the determination unit determines a position corresponding to a direction in which the user moves as the position for placing the at least one virtual object.

2. The image processing apparatus according to claim 1, wherein the image processing unit places the at least one virtual object so that the at least one virtual object moves to a target position over a plurality of frames.

3. The image processing apparatus according to claim 2, wherein, in response to a forward movement as the motion status of the user, the determination unit determines the position for placing the at least one virtual object so that the target position of the at least one virtual object is above the center of the image of the real world.

4. The image processing apparatus according to claim 2, wherein, in response to a descending movement on stairs as the motion status of the user, the determination unit determines the position for placing the at least one virtual object so that the target position of the at least one virtual object is below the center of the image of the real world.

5. The image processing apparatus according to claim 3, wherein the determination unit further changes a range of the target position of the at least one virtual object, depending on a moving speed of the user.

6. The image processing apparatus according to claim 1, wherein the image processing unit changes a frame rate depending on the motion status of the user.

7. The image processing apparatus according to claim 1, wherein the image processing unit adjusts a size of the at least one virtual object over a plurality of frames.

8. The image processing apparatus according to claim 1, wherein, the at least one virtual object comprises a plurality of virtual objects, and the image processing unit places each of the plurality of virtual objects based on a predetermined superimposition priority level.

9. The image processing apparatus according to claim 1, wherein the motion status includes information as to whether the user is moving and about a speed and a traveling direction.

10. The image processing apparatus according to claim 1, wherein the image processing unit places the at least one virtual object after applying image processing to the at least one virtual object depending on the motion status.

11. The image processing apparatus according to claim 10, wherein the image processing is processing of applying shadow to the at least one virtual object.

12. The image processing apparatus according to claim 10, wherein the image processing is processing of applying lighting to the at least one virtual object.

13. The image processing apparatus according to claim 10, wherein the image processing is processing of changing quality of rendering the at least one virtual object.

14. An image processing method to be executed by an image processing apparatus that generates an image of a mixed world by superimposing a virtual object on an image of a real world, the image processing method comprising:
acquiring information related to a motion status of a user of the image processing apparatus;
determining a position for placing the virtual object in the image of the real world, based on the acquired motion status; and
performing image processing of generating an image in which the virtual object is placed at the determined position,
wherein a position corresponding to a direction in which the user moves is determined as the position for placing the virtual object.

15. A non-transitory computer-readable storage medium storing a program for causing a computer to execute a control method for an image processing apparatus that generates an image of a mixed world by superimposing a virtual object on an image of a real world, the control method comprising:
acquiring information related to a motion status of a user of the image processing apparatus;
determining a position for placing the virtual object in the image of the real world, based on the acquired motion status; and
performing image processing of generating an image in which the virtual object is placed at the determined position,
wherein a position corresponding to a direction in which the user moves is determined as the position for placing the virtual object.
